(19) United States
(12) Patent Application Publication
(10) Pub. No.: US 2010/0103683 A1
(43) Pub. Date: Apr. 29, 2010

(54) DIFFUSING LENS AND ILLUMINATION ASSEMBLY USING SAME

(75) Inventor: CHING-SEN TSAI, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/389,492

(22) Filed: Feb. 20, 2009

(30) Foreign Application Priority Data
Oct. 27, 2008 (CN) 200810305233.7

(51) Int. Cl. F21V 5/00; G02B 5/02

(52) U.S. Cl. 362/311.02; 359/707; 362/311.01

(57) ABSTRACT

A diffusing lens is described. The diffusing lens includes an emitting plane and an incident surface including two first refraction portions and two third refraction portions. The two first refraction portions are symmetrically arranged on both sides of the diffusing lens on opposite sides of a central axis of the diffusing lens. The two third refraction portions are symmetrically arranged near the central axis of the diffusing lens and on opposite sides of the central axis of the diffusing lens. The angle between the first refraction portion and the emitting plane is larger than the angle between the third refraction portion and the emitting plane. Thus, by directing some more of the central axis light beams away from the central axis, the light is more uniform after passing through the diffusing lens.

### BACKGROUND

1. Field of the Invention

The present invention relates to illumination assemblies, and particularly, to an illumination assembly used in camera modules of portable electronic devices.

2. Description of Related Art

With the ongoing development of photographing technology, more and more portable electronic devices (e.g., mobile phones and digital cameras) are equipped with illumination assemblies for camera modules to strengthen environmental light for good image exposure.

A typical illumination assembly includes a light source and a planar lens whose central axis is typically coaxial with the light source. The light source usually emits light in radial directions. The radial light is strongest near the center of the lens along the common axis of the light source and the diffusing lens, and the radial light weakens towards the periphery of the lens. Thus, light uniformity is poor.

Therefore, there is room for improvement within the art.

### BRIEF DESCRIPTION OF THE DRAWINGS

Many aspects of the illumination assembly can be better understood with reference to the following drawings. These drawings are not necessarily drawn to scale, the emphasis instead being placed upon clearly illustrating the principles of the present illumination assembly. Moreover, in the drawings like reference numerals designate corresponding sections throughout the several views.

FIG. 1 is a side, exploded view of an illumination assembly, according to an exemplary embodiment.

FIG. 2 is a schematic diagram showing an index path of the illumination assembly shown in FIG. 1.

FIG. 3 is an isometric view of the diffusing lens shown in FIG. 1.

### DETAILED DESCRIPTION OF EXEMPLARY EMBODIMENT

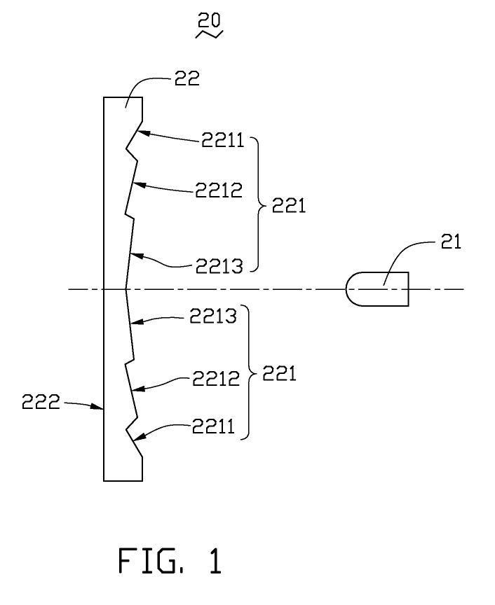

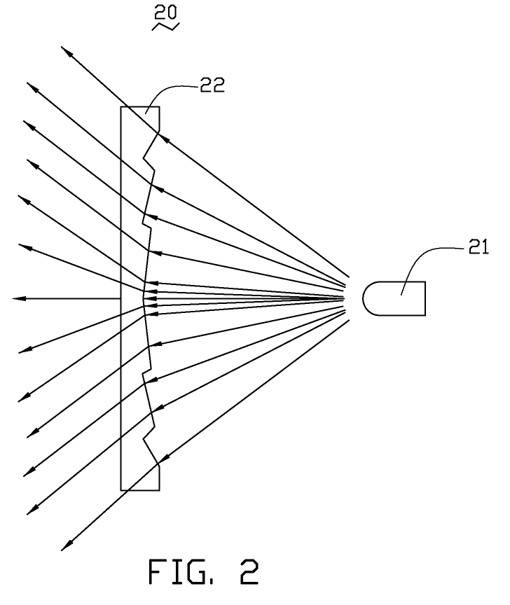

FIGS. 1 and 2 show an exemplary illumination assembly 20 including a light source 21 and a diffusing lens 22. The light source 21 is coaxial with the diffusing lens 22.

The light source 21 may be a light emitting diode (LED). As mentioned above, the emitted radial light by the light source 21 is strongest in the area near the center of the diffusing lens 22, but gradually weakens towards the periphery of the diffusing lens 22, away from the common axis of the light source 21 and the diffusing lens 22.

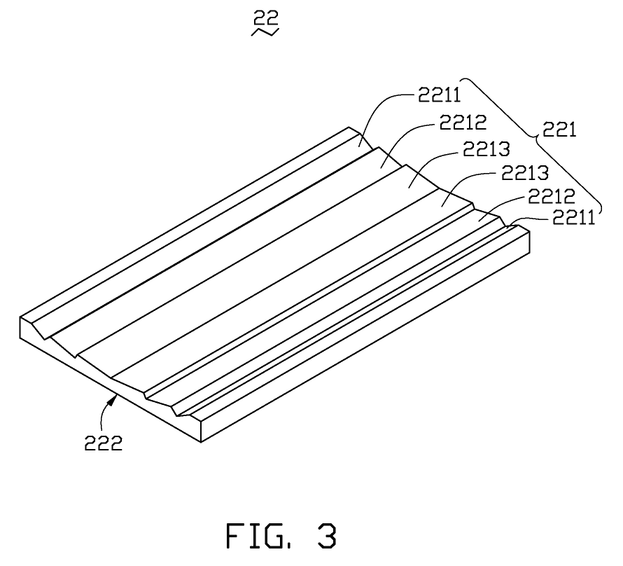

Referring to FIG. 3, the diffusing lens 22 is generally planar and includes a saw-tooth cross-section. The diffusing lens 22 includes an incident surface 221 and an opposite emitting generally flat plane 222.

The incident surface 221 includes, e.g., two first refraction portions 2211, two second refraction portions 2212 and two third refraction portions 2213. The first refraction portions 2211, the second refraction portions 2212 and the third refraction portions 2213 are configured to be sloped. The first refraction portions 2211 are arranged on both sides, and symmetrically about a central axis of the diffusing lens 22. The third refraction portions 2213 are arranged in the center area of the diffusing lens 22 and symmetrically about the central axis of the diffusing lens 22. The second refraction portions 2212 are symmetrically arranged between the first refraction portions 2211 and the third refraction portions 2213. The angle between the first refraction portion 2211 and the emitting plane 222 is larger than the angle between the second refraction portion 2212 and the emitting plane 222. The angle between the second refraction portion 2212 and the emitting plane 222 is larger than the angle between the third refraction portion 2213 and the emitting plane 222.

Referring to FIG. 2, in use, most of light emitted by the light source 21 strikes on the third refraction portions 2213, and the remainder light strikes on the second refraction portions 2212 and the first refraction portions 2211. The light striking on the third refraction portions 2213 refracts outwardly towards the periphery of the diffusing lens 22 with a large refraction angle. The light striking on the second refraction portion 2212 and the first refraction portion 2211 refracts towards the periphery of the diffusing lens 22 with a smaller refraction angle than the third refraction portions 2213. Thus, by directing some more of the central axis light beams away from the central axis, the light is more uniform after passing through the diffusing lens 22.

It is to be understood, however, that even through numerous characteristics and advantages of the present invention have been set forth in the foregoing description, together with details of the structure and function of the invention, the disclosure is illustrative only, and changes may be made in detail, especially in matters of shape, size, and arrangement of sections within the principles of the invention to the full extent indicated by the broad general meaning of the terms, in which the appended claims are expressed.

What is claimed is:

1. A diffusing lens, comprising:
an incident surface including two first refraction portions and two third refraction portions, the two first refraction portions being symmetrically arranged on opposite sides of a central axis of the diffusing lens, the two third refraction portions being symmetrically arranged near the central axis of the diffusing lens and on opposite sides of the central axis of the diffusing lens; and
an emitting plane, the angle between the first refraction portion and the emitting plane being larger than the angle between the third refraction portion and the emitting plane.

2. The diffusing lens as claimed in claim 1, wherein the incident surface further includes two second refraction portions, symmetrically arranged between the first refraction portions and the third refraction portions.

3. The diffusing lens as claimed in claim 2, wherein the angle between the first refraction portion and the emitting plane is larger than the angle between the second refraction portion and the emitting plane, the angle between the second refraction portion and the emitting plane is larger than the angle between the third refraction portion and the emitting plane.

4. An illumination assembly comprising:
a light source; and
a diffusing lens including an incident surface and an emitting plane, the incident surface including two first refraction portions and two third refraction portions, the two first refraction portions being symmetrically arranged on opposite sides of a central axis of the diffusing lens, the two third refraction portions being symmetrically arranged near the central axis of the diffusing lens and on opposite sides of the central axis of the diffusing lens, the angle between the first refraction portion and the emitting plane being larger than the angle between the third refraction portion and the emitting plane.

5. The illumination assembly as claimed in claim 4, wherein the incident surface further includes two second refraction portions, symmetrically arranged between the first refraction portions and the third refraction portions.

6. The illumination assembly as claimed in claim 5, wherein the angle between the first refraction portion and the emitting plane is larger than the angle between the second refraction portion and the emitting plane, the angle between the second refraction portion and the emitting plane is larger than the angle between the third refraction portion and the emitting plane.

7. The illumination assembly as claimed in claim 4, wherein the light source is a light emitting diode.

8. A portable electronic device equipped with an illumination assembly, the illumination assembly comprising:
a light source; and
a diffusing lens including an incident surface and an emitting plane, the incident surface including two first refraction portions and two third refraction portions, the two first refraction portions being symmetrically arranged on opposite sides of a central axis of the diffusing lens, the two third refraction portions being symmetrically arranged near the central axis of the diffusing lens and on opposite sides of the central axis of the diffusing lens, the angle between the first refraction portion and the emitting plane being larger than the angle between the third refraction portion and the emitting plane.

9. The portable electronic device as claimed in claim 8, wherein the incident surface further includes two second refraction portions, symmetrically arranged between the first refraction portions and the third refraction portions.

10. The portable electronic device as claimed in claim 9, wherein the angle between the first refraction portion and the emitting plane is larger than the angle between the second refraction portion and the emitting plane, the angle between the second refraction portion and the emitting plane is larger than the angle between the third refraction portion and the emitting plane.
